(19) United States
(12) Patent Application Publication
(10) Pub. No.: US 2003/0120801 A1
(43) Pub. Date: Jun. 26, 2003

(54) Method and apparatus for a group communication system

(76) Inventors: Darin W. Keever, Austin, TX (US); Corey M. Rhoden, Austin, TX (US); Ken L. White, Cedar Park, TX (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/027,546

(22) Filed: Dec. 21, 2001

(51) Int. Cl. G06F 15/16

(52) U.S. Cl. 709/237

(57) ABSTRACT

A method for communicating between a group of members includes identifying a group of selected members, assigning the members of the selected group to an exclusive communication channel, initiating communication without the need for a dialing mechanism, and communicating between members of the selected group over the exclusive communication channel. A communication system used to communicate between selected members includes user nodes, access points, and routers.

### FIELD OF THE INVENTION

This invention generally relates to a communication system and more specifically to a method and apparatus to communicate between a group of users.

### BACKGROUND OF THE INVENTION

Many patrons of large entertainment venues, such as ski resorts, resort hotels, and theme parks, are families and other groups. Families and groups rarely stay together for the duration of their stay at an entertainment venue. More often, group members separate to indulge their individual interests. Because many popular entertainment venues are large and crowded, keeping track of separated group members may be a challenge.

Typical existing communication systems such as cellular phones and Citizen Band (CB) radios are not convenient for group communication in entertainment venues. Group communication is the ability to seamlessly communicate between group members without the need for setting up independent calls or communication channels between each member of a user defined group. A user defined group, such as a group of family members that wish to communicate at an entertainment venue, is referred to as a micronet. The members of the user defined group (e.g. family members) are referred to as micronet members. With group communication capabilities, a micronet member may send a message that is received by all other members of the micronet substantially simultaneously. Group communication also allows a micronet member to receive messages from all other members of the micronet.

Cellular phone calls are typically initiated by dialing, which is the entering of an identification number corresponding to the recipient of the call. Because the membership of a micronet is subject to change and a portable communication device at an entertainment venue will most likely be temporarily rented, it would be difficult for micronet members to keep track of numbers for other members. Ordinarily, cellular phones are not equipped for group communication and are used for communicating between two parties on an exclusive communication channel. Communication with a cellular phone is not continuous; a call must be re-initiated, and a number must be re-dialed, each time communication is desired. In order to use a cellular phone for micronet group communication, users have to know member cellular phone numbers, and initiate separate calls for each member of the micronet in order to communicate to each member. Because cellular phones require dialing, do not provide continuous communication, and do not ordinarily have communication capabilities for groups with more than two members, cellular phones are not convenient for group communication.

CB radios are devices that send messages back and forth over a set of pre-defined, continuous channels. There is no need for dialing or re-establishing a call each time communication is desired. The discrete number of pre-defined channels is predetermined by the CB radio equipment manufacturer. As the number of groups at an entertainment venue increases, the likelihood of interference increases because group communication is limited to the discrete number of channels. Furthermore, there is generally no control on channel access and channel exclusivity. Therefore, multiple groups of users may be attempting to communicate on the same channel simultaneously.

It is more convenient for users who are members of a micronet to communicate over a dedicated, exclusive channel. If a micronet is assigned to an exclusive channel, a non-member user with a portable communication device will not readily be able to eavesdrop on the micronet communication. Nor should the non-member be able to send messages to members of the micronet. However, a non-member may be added to the micronet, or a member may be removed from the micronet, at any time. This ability to dynamically add and remove members from a micronet “on the fly” is useful because not all micronet members arrive or depart from an entertainment venue at the same time. Because CB radios do not provide exclusive communication channels and capabilities that could be used to update the membership of a micronet, CB radios are not convenient for group communication in entertainment venues.

It should be noted that an exclusive channel is exclusive in the functional sense, and not necessarily in the physical sense. It is possible that multiple micronets may use the same physical channel to send and receive messages, while having exclusive communication within the micronets. For example, multiple micronets may be using different time slices of the same time domain multiplexed channel.

A convenient group communication system will be a revenue source for entertainment venue owners who may rent portable communication devices to patrons for the duration of their stay. CB Radios, like cellular phones, are not advantageous to the venue owners as groups can bring their own devices. Even in a rental scheme, some customers may supply their own devices. A new communication system that provides convenient communication will benefit both entertainment venue owners who can generate revenue from renting portable communication devices, and patrons who will have a superior way to communicate.

### BRIEF DESCRIPTION OF THE DRAWINGS

FIG. 1 illustrates one embodiment of the invention to implement a group communications system.

FIG. 2 illustrates one example of a communication method for a group communication system implementing an embodiment of the invention.

FIG. 3A illustrates an embodiment of a user node device implementing the invention.

FIG. 3B illustrates another embodiment of a user node device having additional features.

FIG. 4 illustrates a flow diagram of a method of the present invention for forming a micronet and communicating between micronet members.

FIG. 5 illustrates one embodiment of a method for sending micronet messages.

FIG. 6 illustrates a flow diagram exemplifying a router technique for communicating micronet messages.

FIG. 7 illustrates a method for user node device operation.

FIG. 8 illustrates one example of micronet and user transmitter states for a system with a lock timer.

FIG. 9 illustrates one example of micronet and user transmitter states for a system without a lock timer.

FIG. 10 illustrates one example application utilizing the invention in an entertainment venue.

### DETAILED DESCRIPTION OF THE INVENTION

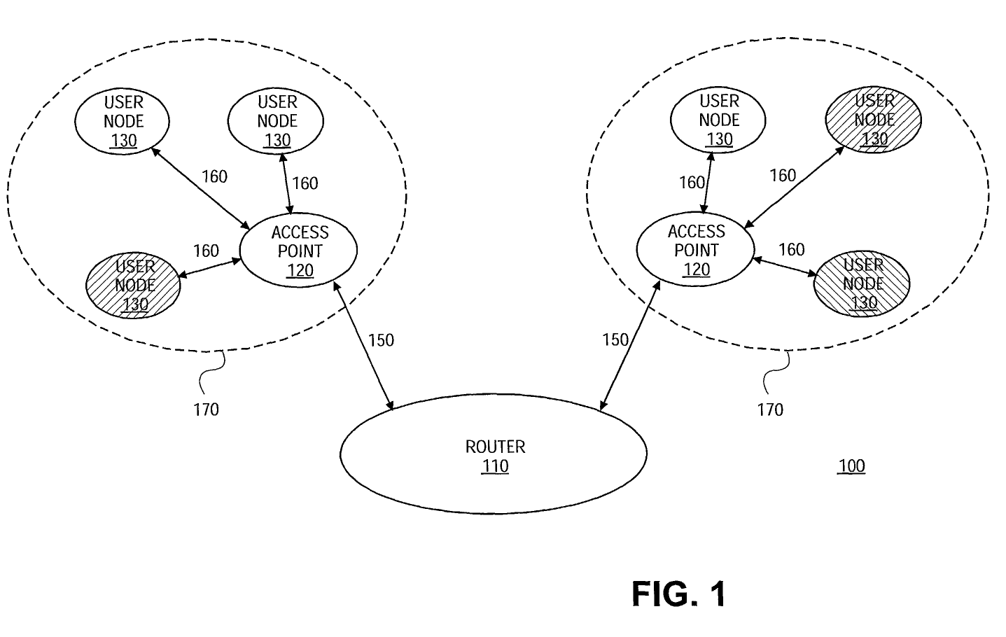

FIG. 1 illustrates one embodiment of a communications system 100 to practice the invention. The communications system 100 includes a router 110, two access points 120, and six user nodes 130. In actual practice, the number of system components may vary and may not be limited to the number shown in FIG. 1. For example, there may be multiple routers 110, any number of user nodes 130, and any number of access points 120. The router 110 is coupled to the access points 120 with a transmission channel 150. The router 110 and the access points 120 communicate over the transmission channel 150 by sending and receiving messages. In one embodiment the transmission channel 150 is a wire-line transmission channel. For example, the transmission channel 150 may be twisted copper wire or coaxial cable. In another embodiment, the transmission channel 150 is a wireless transmission channel.

Access points 120 communicate with user nodes 130 by sending and receiving messages over a transmission channel 160. In one embodiment, the transmission channel 160 is a wireless channel. The access points 120 typically communicate over the transmission channel 160 to user nodes 130 within a defined range 170. The range 170 is an area proximal to the access point 120 within which communication is possible between an access point 120 and user nodes 130. This range will vary depending on the particular system. In an alternative embodiment, where a user node 130 has the ability to communicate directly with the router 110, the defined range 170 will include an area to allow direct communication with the router 110. If a user node 130 is outside the range 170, communication between the user node 130 and access point 120 may not transpire. A large entertainment venue may deploy an appropriate amount of access points 120 to ensure that various areas of the venue are within range 170 of an access point 120.

In FIG. 1, some of the user nodes 130 are shaded to illustrate the concept of a micronet. Thus, shaded user nodes 130 form one micronet and the remaining unshaded user nodes 130 form another micronet. A micronet is generally a group of member user nodes, such as user nodes 130, which communicate exclusively with the members of the micronet group. For example, a message sent from anyone of the shaded user nodes 130 may be received by the other shaded user nodes 130. However, the message sent by one of the shaded user nodes 130 will not be received by any of the unshaded user nodes 130 because they are not within the shaded micronet. Messages sent between the unshaded user nodes 130 may not be received by the shaded user nodes 130, but will be received by the user nodes 130 in the unshaded micronet. Therefore, when a member of a micronet sends a message, all other members of the micronet that are in range 170 may receive the message, but the user nodes 130 which are not members of the micronet do not receive the message.

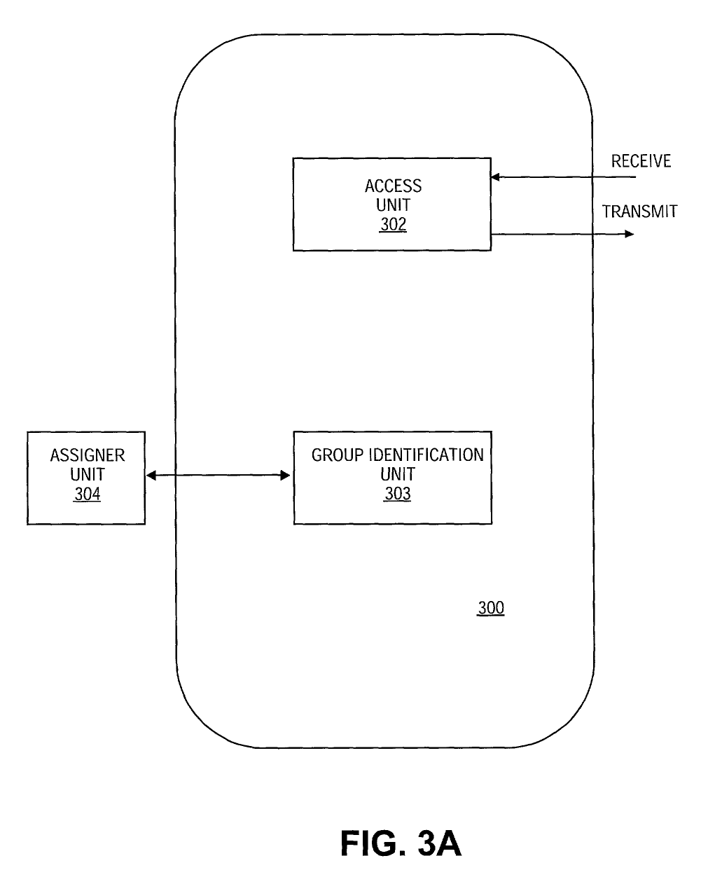

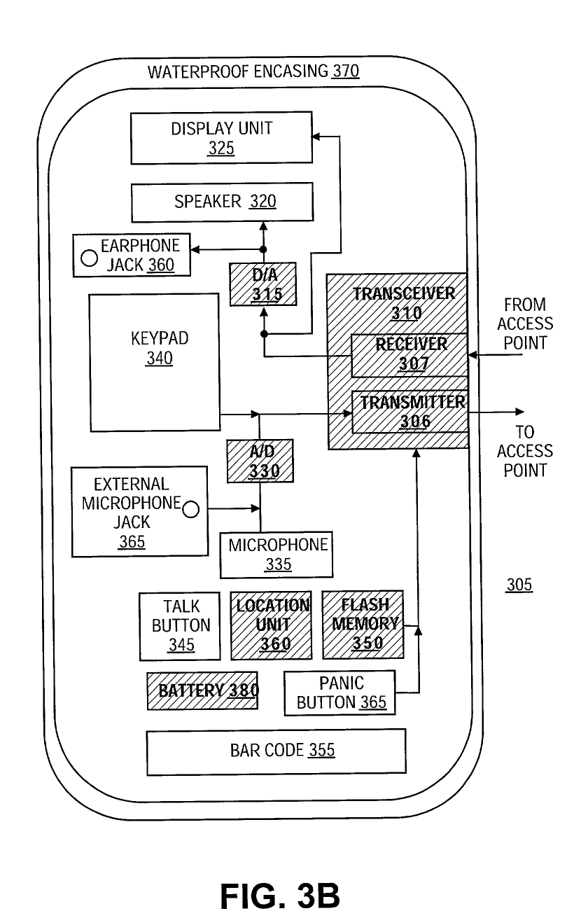

A user node 130 generally comprises a user and a user node device, which enables the communication. The user node device, which will be discussed in relation to FIG. 3A and FIG. 3B, typically includes a transceiver capable of sending and receiving messages over the transmission channel 160 to the access points 120. The access points 120 may include two separate transceivers: one to enable communication with user nodes 130 over transmission channel 160 and one to communicate over transmission channel 150 with the router 110. These two transceivers may be of the same type or different type. The router 110 may have more than one type of transceiver to communicate to access points 120 over various kinds of transmission channels 150. It is possible that one access point 120 will communicate with the router 110 over a wireless channel 150 and another access point 120 will communicate with the router 110 over a wire-line channel 150. It is also within the scope of the present invention to have a user node 130 communicate directly with the router 110. Access points 120 may be used to extend the range of the overall communication system 100 to cover the operating area.

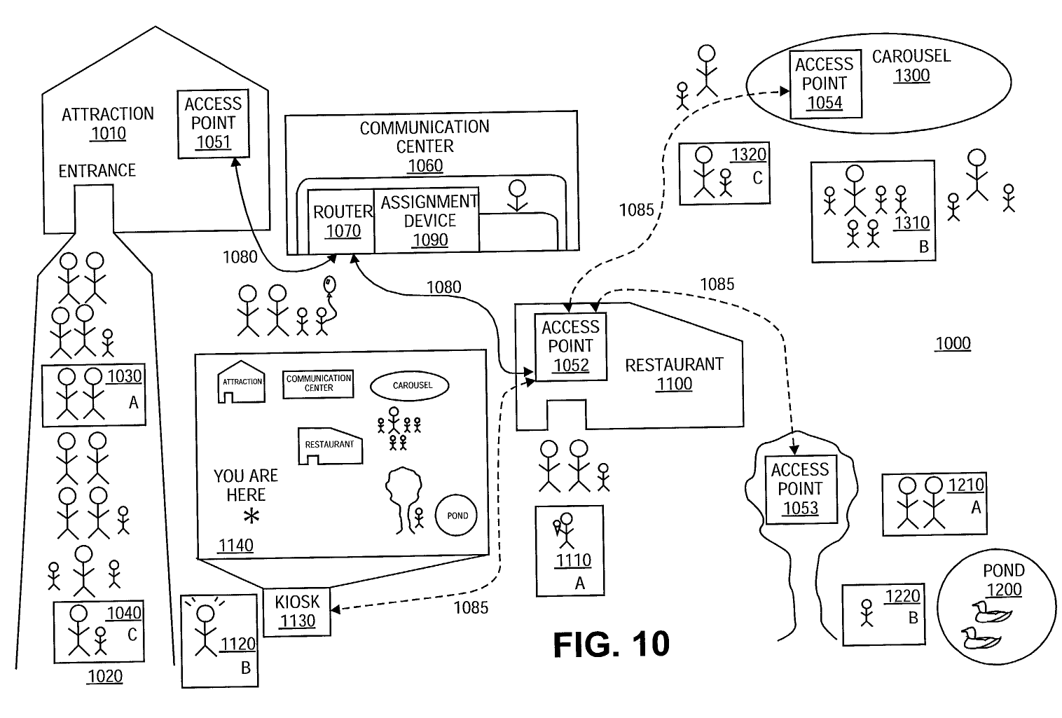

For example, if a new area of a venue is opened which is outside the original range 170 of an access point 120, an operator or group communication system installer may not wish to run a transmission line 150 from the router 110 all the way to a new access point 120 installed in the new area. Instead, an access point 120 which is connected to the router 110 via a transmission line 150 may be used to receive messages from the new access point 120 and forward the messages on to the router 110. If none of the existing access points 120 is in range of the new access point 120, an additional access point 120, which is in range of both the new access point 120 and an existing access point 120 which is coupled to a transmission line 150, may be installed. This intermediate access point 120 forwards messages from the new access point 120 to the access point 120 which is coupled with the router 110. An intermediate access point, also referred to as a repeater, will be subsequently described in relation to FIG. 10.

The user nodes 130, access points 120, and router 110 may use one of many different types of transceivers corresponding to different communication protocols, as well as combinations of transceiver types based on system constraints such as cost, size of venue, and venue environment. Examples of types of transceivers/communication protocols are Digital Subscriber Line (DSL), Integrated Services Digital Network (ISDN), Institute of Electrical and Electronics Engineers (IEEE) 802.11b wireless network standards, and Bluetooth.

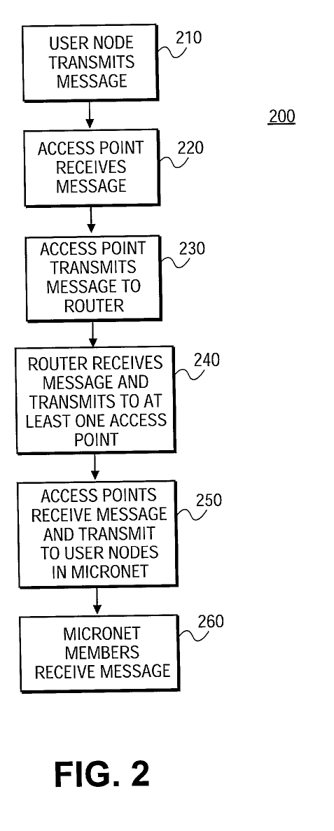

FIG. 2 illustrates one example flow diagram of a communication scheme 200 which may be implemented by a communication system such as system 100 of FIG. 1. In block 210, a user node, which is a member of a given micronet, transmits a message. In block 220, an access point within range of the user node receives the message. The access point proceeds to transmit the message to a router in block 230. In an alternative embodiment, the access point transmits the message to an intermediate access point, and then the intermediate access point forwards the message on to the router.

The router receives the message and transmits the message to at least one access point in block 240. In one embodiment, the router transmits the message to all access points in the system. In this embodiment, the router may not have any information regarding which access points are in range of the members of the given micronet. Therefore, the router sends the message to all access points. In another embodiment, the router does have information regarding which access points are in range of the micronet members, and only transmits the message to those access points which are in range of a member of the given micronet. The router may choose not to transmit the message to an access point in range of a member of the given micronet, if the only member in range is the member who originated the message.

In block 250, at least one access point receives the message from the router and transmits the message to user nodes which are members of the given micronet within the range of the access point. In one embodiment, the access point has information regarding which micronet members are in range and the access point only transmits the message if a member of the given micronet is in range. In another embodiment, the access point automatically transmits the message without identifying which user nodes are within range. Finally, in block 260, the micronet members receive the message from the access points that are in range.

When the access point transmits a message, the message may include destination and/or source information that may be used by the user node to accept or reject the message. If an access point sends a message over a wireless transmission channel, it will be received by all the user nodes within the range of the access point. However, a user node may reject the message if the message includes destination and/or source information which indicates that the message originated from a user node which is not a member of the given micronet. Therefore, although the user node receives the message from a non-member, the user node rejects the message before it is made available to the user.

FIG. 3A illustrates an embodiment of a basic user node device 300 to practice the present invention. The user node device 300 includes an access unit 302 and a group identification unit 303. The access unit 302 may include a transmitter, a receiver or both. The access unit 302 is used to communicate information over a communication channel. More specifically, the access unit 302 may receive and/or transmit various kinds of messages and information between one or more user node devices 300 via a router, access point, or access point/router combination. There are many different types of transmitters, receivers, and transceivers that can be included in the access unit 302.

The group identification unit 303 may be coupled with the access unit 302 and may be used in conjunction with an assigner unit 304 to assign the user node device 300 to a micronet. If the user node device 300 is selected as a member of a user defined micronet group, the assigner unit 304 may assign the user node device 300 to the given micronet. The assigner unit 304, or an additional unit which may be part of a computer system or communication system, may assign the user node device 300 to an exclusive communication channel that is used solely by the members of the given micronet. The assigner unit 304 may assign the user node device 300 to a micronet, or may assign the user node device 300 to an exclusive communication channel, or both.

In one embodiment, the assigner unit 304 may be a computer or communication device coupled with a bar code reader. The group identification unit 303 may be a bar code coupled with the user node device 300. The bar code reader may be used to read the bar code information on the user node device 300. The information read from the bar code may be stored, such as on a computer, and used to associate the user node device 300 with other members of a user defined micronet. The information read from the bar code may be added to a list that includes information about each user node device assigned to a given micronet. This list may be used to assign the members of the list to an exclusive communication channel. This list may also be used by a communication device such as a router or access point device to facilitate exclusive communication between the members of the micronet. For example, a router or access point may identify that the source of a message is a user node device 300 listed as a member of a specific micronet and determine based on the list of members where the message should be routed in order to reach the other members of the micronet.

In another embodiment, the assignment unit 304 may be a computer or communication device coupled with a programming device and the group identification unit 303 may be a programmable device coupled with the user node device 300. In this embodiment, the programming device may program micronet group identification information into the group identification unit 303. The group identification information may be included in messages transmitted by the user node device 300. This programmed group identification information may be used by routers, access points, and other user node devices 300 to facilitate communication between members of the micronet. For example the programmed group identification information may be embedded in a message indicating a source and/or destination of the message. In some instances both a bar code and a programmable device may be included in the user node device 300 to facilitate communication between members of the micronet.

FIG. 3B illustrates a more detailed embodiment of a user node device 305 to practice the present invention. Components that will typically be internal to the user node device 305 are shown as shaded components, and components that are typically accessible to a user on the surface of the user node device 305 are unshaded. The user node device 305 includes a transceiver 310. The transceiver 310 may be of a variety of transceivers. For example, the transceiver 310 may be compliant with a known standard such as the IEEE 802.11b Wireless Network Standard. The transceiver 310 includes a receiver 307 and a transmitter 306. The receiver 307 receives messages sent from access points or routers to the user node. The transmitter 306 transmits messages from the user node to access points or routers. In one embodiment the message received by the receiver 307 is a voice message. Typically, the received message from a transmission channel is in a digital format. Therefore, in order to listen to a voice message, the received digital message is converted into an analog audio signal. A digital to analog (D/A) converter 315 is coupled to the receiver 307. The D/A converter 315 converts the digital message into an analog audio signal. The D/A converter 315 is also coupled to a speaker 320. The speaker 320, an example of a user output device, plays the converted audio signal.

The user node device 305 is also capable of sending a voice message. A user input device, such as a microphone 335, captures audio signals. The microphone is coupled to an analog to digital (A/D) converter 330. The A/D converter 330 converts audio signals into a digital format and is coupled to the transmitter 306 to provide a digitally formatted voice message to the transmitter 306. In alternative embodiments, the A/D and D/A converters 315 and 330 may be included in the transmitter 306, receiver 307, respectively.

The messages sent and received by the transceiver 310 may also be text messages. The receiver 307 may be coupled with a user output device, such as a display unit 325. Therefore, if a text message is received by the receiver 307, it can be displayed to the user with the display unit 325. If the user wishes to send a text message, the keypad 340 can be used as a user input device to form the message. The keypad 340 is coupled with the transmitter 305 so that it can provide a text message to the transmitter 306.

In order to capture a voice message from a user through the microphone 335, the talk button 345 may be used. The talk button 345 may be used to both initiate the sending of the voice message and to terminate the sending of the voice message. When a user wishes to send a voice message, the user depresses the talk button 345 and holds the talk button down until the voice message is complete. Once the talk button 345 is released by the user, the voice message may be terminated. It is also possible to use a combination of a talk button 345 and/or other buttons to capture, send, and terminate messages.

The user node device 305 may be portable and may be worn on the user's body. For example, the user node device 305 can be connected with a clip to the user's belt or pinned on to the user's shirt. In order to provide more flexibility to the user, an earphone jack 360 and/or an external microphone jack 365 may be used. Therefore, a user can wear a head set with earphones and a microphone which can be connected to the ear phone jack 360 and the external microphone jack 365 for easier operation. In an alternative embodiment, the phone jack 360 and external microphone jack 365 may be combined into a single jack. The user node device 305 may also be encased in a waterproof material 370.

The user node device 305 typically includes a power source. For example, the power source may be a battery 380. The user node device 305 may also include a panic button 365. The panic button 365 may be used for emergencies. For example, if a user depresses the panic button 365, it may alert the venue security that there is a problem. Other devices not shown in FIG. 3B may also be included such as a mute button and a voice recognition unit. For example, the voice recognition unit may be used to recognize voice commands. In more sophisticated devices, the voice recognition unit may convert an audio voice message into a text message before the message is transmitted. Conversely, the received text message may be converted back into an audio voice message by a voice synthesizer that converts text into audio.

In order for the user node device 305 to be used in a micronet group, the user node device 305 or the overall communication system, may be configured for an exclusive communication channel. Typically, a communication system assigns an identification number to a communication device, and the identification number serves as a source address when sending a message and a destination address when receiving a message. In one embodiment, the identification number for a given user node device 305 is static. For example, a router and/or access point may have a list of static identification numbers for various user node devices 305 which are assigned to a specific micronet. The list of member user node devices 305 may be formed by scanning bar codes 355 on user node devices. Therefore, the micronet membership is based on a list of static addresses, associated with individual user node devices 305, which are scanned from bar codes 355 on the user node devices 305 to be used by the micronet members.

In an alternative embodiment, the user node device 305 may have a dynamic identification number, which is programmed when a micronet is formed. In this embodiment, a programmable memory device such as the flash memory 350 may be used to store a dynamic identification number for the user node device 305.

The user node device 305 may also include a location unit 360. The location unit 360 can be used to determine where the user is within the service or operating area. In one embodiment, the location unit 360 is a global position satellite (GPS) device which uses satellite based radio-navigation. GPS satellites read the signals sent by a GPS device, such as location unit 360, and return location information to the GPS device. In another yembodiment, instead of using GPS, the location unit 360 may send a location request signal to a group of access points, which then return location information to the location unit 360, and the specific location is determined triangulation.

Location information may be displayed on an external display unit. For example, location information may be displayed on an external kiosk within the vicinity of the user node to show the user's proximity to a given location. Additionally, the various locations of the micronet members may also be displayed. In another embodiment, location information may be displayed on the internal display unit 325.

Within a micronet, it is possible to have one or more subsets of members called sub-micronets. A sub-micronet has a separate exclusive communication channel used by a subset of the micronet group members. Therefore, a user of a sub-micronet may have access to the exclusive micronet communication channel used to communicate with all members of the micronet group and one or more additional exclusive communication channels to communicate privately with a subset of the group members. The user node device 305 may include a channel switch, for example to activate communication on a sub-micronet channel, or another mechanism for selecting communication with a subset of the micronet members.

It is within the scope of the present invention to have various combinations of features and devices included in the user node device 305. The user node devices shown, 300 and 305, illustrate examples of a user node device, and are not meant to limit the various combinations of features and devices.

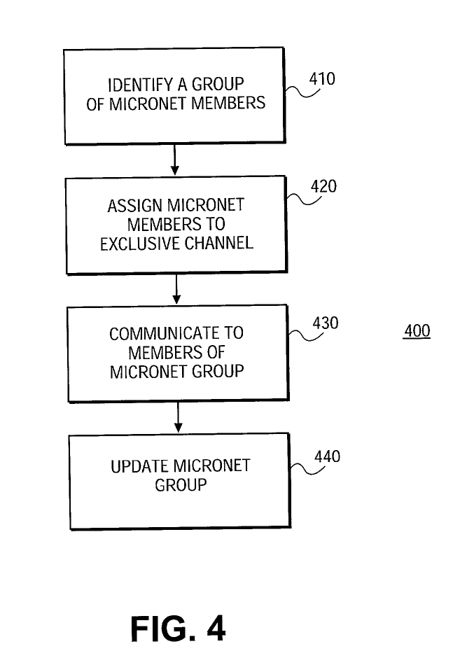

FIG. 4 illustrates one embodiment of a flow diagram 400 to practice the present invention. First, a group of micronet members is identified (block 410). For example, a family arriving at an amusement park may wish to rent a communication device for each member of the family. The family members approach a user node device vendor at the amusement park and request a user node device for specific family members. Therefore, the micronet group is identified as the family members. After the group of micronet members are identified, the user node devices for each member are assigned to an exclusive communication channel (block 420). In one embodiment, the user node devices are assigned to an exclusive channel by dynamically programming the user node devices with specific identification numbers or addresses. In this embodiment, the identification numbers may be used as source and/or destination addresses for micronet communications. For example, a message from an access point or router that includes a specific identification number in the form of a source address may indicate which micronet the message is from. The user node devices may reject messages with source addresses from non-members based on a list of micronet member identification numbers, which is programmed into the user node device flash memory.

In an alternative embodiment, assignment of members of the micronet group to an exclusive channel (block 420) includes using a bar code. In this embodiment, each one of the user node devices may have a distinct, static bar code. The bar code may correspond to a specific source and/or destination address. The bar code for each micronet group member can be scanned into a group list which is used by a router and/or access point. When the router and/or access point receives a message from one of the group members, the message will be sent to all of the addresses other than the source of the message in the micronet group list. It is within the scope of the present invention to use a combination of static information and dynamic information to assign and operate over an exclusive micronet channel. For example, both a bar code and a flash memory may be used.

After assigning the members of the micronet group to an exclusive communication channel, the members of the micronet group can communicate (block 430). At any given time, the members of the micronet group can be updated (block 440). For example, one of the family members may decide to leave the amusement park. The user node device assigned to that family member can be removed from the micronet group. In one embodiment, the user node device is removed from the micronet group by rescanning the bar code on the user node device and removing the corresponding source and/or destination address from the micronet group list. In another embodiment, the user node device for the member who is leaving the micronet group can be reprogrammed. The user node device can be reassigned to another micronet group simply by either reprogramming the user node device to have new identification information or to add the identification number corresponding to the bar code on that user node device to a list for another micronet group.

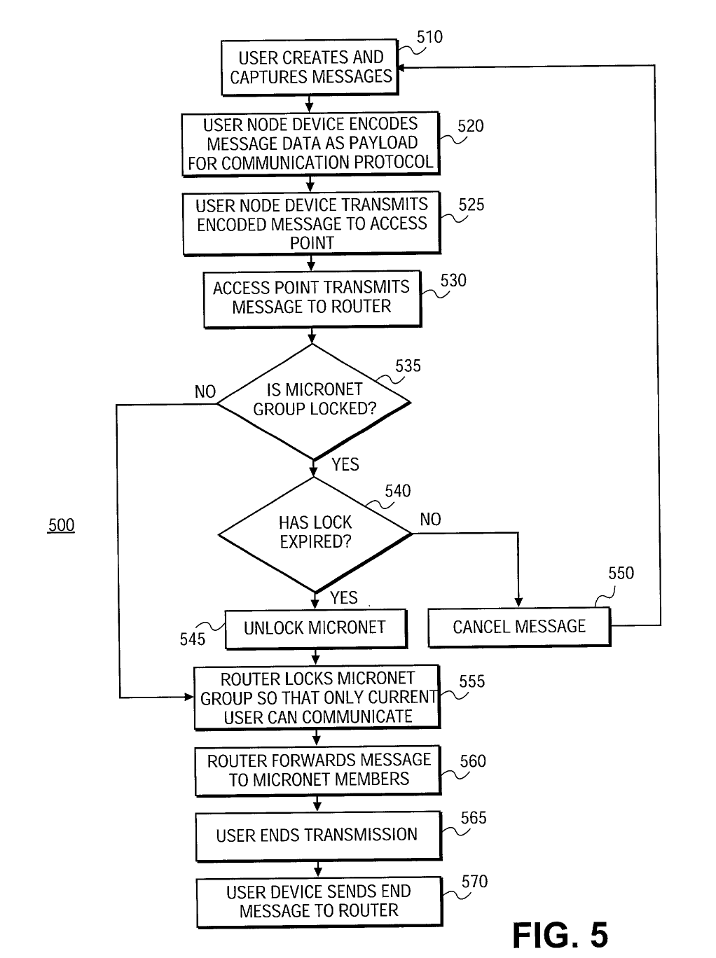

FIG. 5 illustrates one embodiment of a flow diagram 500 for sending and receiving messages for a micronet. The flow diagram 500 is a detailed illustration of one embodiment of block 430 of FIG. 4. A user creates and captures a message. In one embodiment the message is a text message (block 510). In this embodiment, the message may be created and captured by typing on the user node device keypad. In another embodiment, the message is a voice message. A voice message may be created and captured by a user depressing a talk button and speaking into a microphone. In yet another embodiment, a text message may be created by capturing a voice message and using a voice recognition device to convert the message to a text message. After the message has been fully or partially created and captured, the user node device encodes the message data as payload for a given communication protocol (block 520). In one embodiment, the communication protocol used is the IEEE 802.11b standardized protocol. It is appreciated that there are many different communication protocols that can be used to transmit and receive text and voice messages.

Once the user node device encodes the message data as payload for the communication protocol (block 520), the user node device transmits the encoded message data to an access point (block 525). In an alternative embodiment, the user node device may transmit the encoded message directly to a router. It should be noted that it is not necessary to wait for the full message to be captured before a portion of the message is encoded (block 520) and transmitted (block 525). The user node device may wait until the entire message is captured prior to encoding and transmitting the message data. Or, the user node device may be encoding and transmitting a first portion of the message data while it is still capturing a second portion of the message data.

The access point then transmits the message to a router (block 530). In an alternative embodiment, the access point transmits the message to another access point, which then may forward the message to another access point or to a router. In this scenario, multiple access points may be used as intermediate repeaters to extend the range of a communication system.

When the router receives the message from the access point, it may check to see if the target micronet group has previously been locked. In one embodiment, only one micronet group member can be sending a message at any given time. When the router receives a message from a micronet member and there are no outstanding messages for the micronet, the router may lock the micronet group so that no other members can transmit a message, and the router starts a timer for the lock. The lock is typically implemented in software.

The router checks to see if the micronet group is locked (block 535). If the micronet group is locked, then it may still be possible to transmit the message if the lock has timed-out. The router checks to see if the lock has expired (block 540). If the lock has expired, then the micronet group is unlocked (block 545). If the lock has not expired, then another member of the micronet group may currently be transmitting a message and the router cancels the new message in block 550. If the router cancels the message, the user may try again to create and capture a message (block 510).

Referring back to block 535, if it is determined that the micronet group is not locked, which may indicate that there are no other members in the micronet group currently transmitting a message, the router locks the micronet group so that only the current user can send a message (block 555). After locking the micronet group, the router forwards the message to members of the micronet group (block 560). In one embodiment, the message is not forwarded to the member from which the message originated. Messages may be transmitting directly to the member user nodes or indirectly through access points. After the user ends transmission (block 565), the user node device sends an end message indication, directly or indirectly through one or more access points, to the router (block 570). In one embodiment, the user ends transmission by releasing a talk button or pressing an “end” button on the user node device which may be part of a keypad. In this embodiment, the user node device will send an end message indication to the router when the talk button is released or the “end” button is pressed. Typically, the format and contents of the end message indication will be communication protocol dependent and are outside the scope of the present invention.

In an alternative embodiment, the router will unlock the micronet group when it receives the end message indication. In this embodiment, the router will not need to use a timer or check a lock timeout to determine if a new message should be sent, but will only need to check if the micronet group is locked. In yet another embodiment, a timer is used, but the micronet group is unlocked automatically when the lock expires. This embodiment may be implemented with a hardware or software interrupt, triggered by the lock period expiring, which unlocks the micronet group. Combinations of the embodiment shown in FIG. 5 and the two embodiments discussed in this paragraph may be used to handle the locking and unlocking of the micronet group.

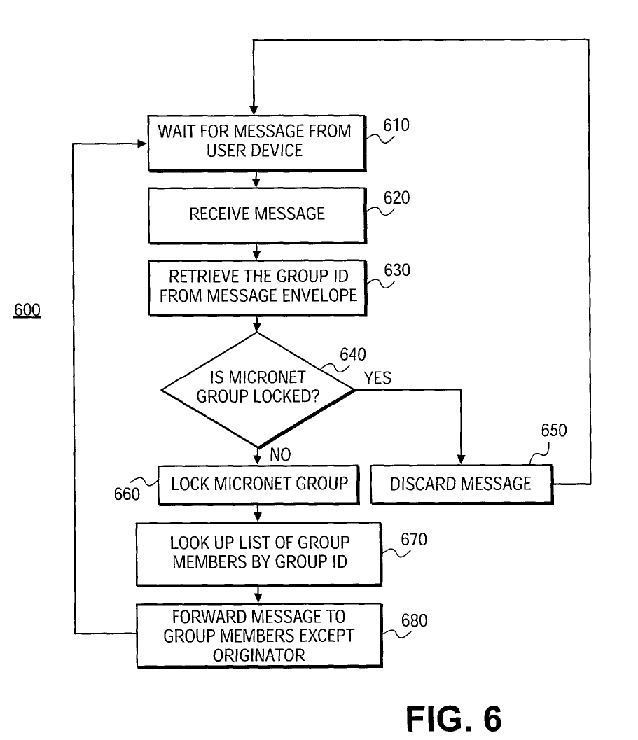

FIG. 6 illustrates a flow diagram 600 for one embodiment of a router operation for the present invention. The router waits for an incoming message (block 610). The message may come directly from a user node or from an access point. The router receives a message (block 620). Next, the router retrieves the micronet group information embedded in the message (block 630). As was mentioned in the description of FIG. 2, the micronet group information embedded in the message may correspond to a bar code on the user node device or may be programmed into the device flash memory. In one embodiment, the micronet group information is in the form of a number in a field contained in the message.

The micronet group information may represent the micronet group identification (ID). Once the router knows what the group ID is for the message source, it checks to see if the corresponding micronet group is locked (block 640). For example, the router may have a list of micronets ID's corresponding to those that are locked. If the micronet group is locked, the router discards the message in (block 650). Once the message is discarded the router waits for a message (block 610). In an alternative embodiment, the router may store the received message in a message queue instead of discarding it. Subsequently, after the micronet group is unlocked, the queue message can be forwarded on to the members of the micronet group.

If the micronet group is not locked, the router locks the group (block 660). The router looks up the list of group micronet members based on the group ID (block 670), which may have been previously determined or may be embedded in the message. After identifying the group members from the list, the router forwards the message to all the group members, except for the originator of the message (block 680). In one embodiment, the message is forwarded to micronet group members directly. In another embodiment, the message is forwarded to access points, and then on to the micronet group members.

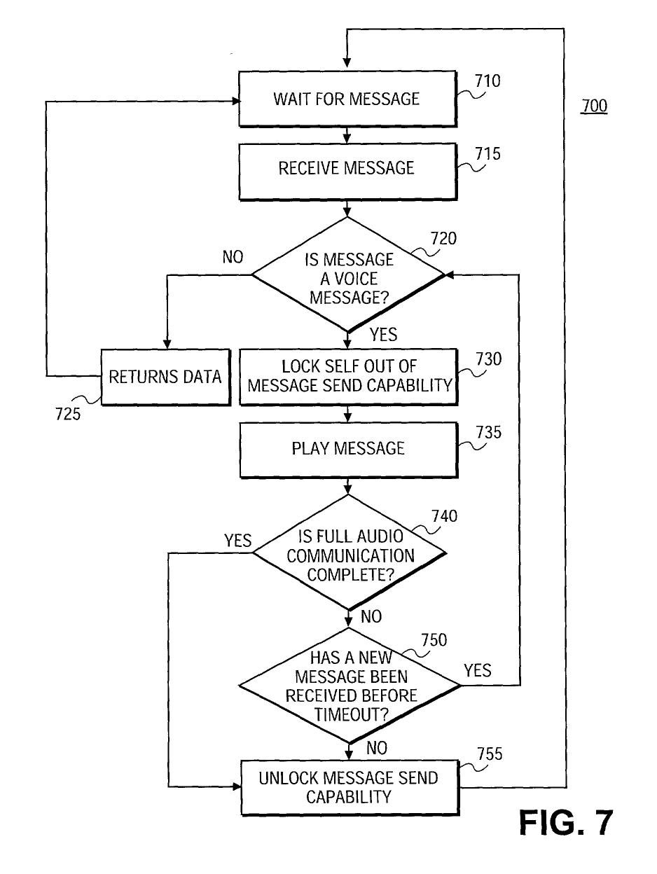

FIG. 7 illustrates a flow diagram 700 for one embodiment of user node device operation for the present invention. An example of a user node device, which may operate in the manner described in diagram 700, is the user node device 305 of FIG. 3B. The user node device waits for a message (block 710). The user node device may wait to capture a new message from the user to be transmitted, or the user may wait to receive a message from a router or access point that originated from a micronet group member. The flow diagram 700 addresses receiving a message originating from a micronet group member. One embodiment for capturing a message was previously described in the flow diagram 500 in FIG. 5, and may be combined with the flow diagram 700.

The user node device receives a message (block 715). Once a message is received, the user node device determines if the message is a voice message (block 720). If the message is not a voice message, then the user node device may return data (block 725). There are many types of messages that may be received. For example, messages to update the software version running on the user node device and messages to inform the user node device that a micronet member has been deleted or added to the group are possible. Another example of a message received may be a type of location information request, referred to as a range request. The user node device may reply with location information (block 725), and then return to wait for messages (block 710).

Access points and routers may keep track of which user node devices are within their range. One method of keeping track of user nodes is to periodically send a range request. User node devices that are within range of the requesting access point or router may respond with a signal indicating that the user node device is within range, and may include user node device identification information. In an alternative embodiment, if the message relates to a location information reply, the user node device may display the information, and then return to wait for messages (block 710). An example of a location is information reply message is specific location information of a user node device from a GPS or triangulating access point system which is sent in response to a location request from the user node device.

Referring to block 720, if the message is a voice message, the user node device locks out the message capture capability (block 730). In one embodiment, the communication system may be capable of half-duplex operation (the user node device does not transmit and receive messages at the same time), and the audio capture capability, a transmit operation, may be locked out by disabling the talk button when a message is received. The talk button is part of the embodiment of a user node device 305 described in FIG. 3B. The communication system may be capable of full-duplex operation (the user node device can send and receive messages simultaneously) and the locking self out of message send capability (block 730) may not be performed. Although it is not relevant to the discussion of FIG. 7, it is within the scope of the present invention to have simplex user node devices which may only have the capability to either receive or transmit.

Next, The user node device plays the audio message through a speaker (block 735). Typical communication protocols have limits on the amount of data that can be sent per message. The audio data captured by the sending user node device may be significantly larger than the communication protocol can support in a single message. Therefore, the communication protocol may require that multiple messages be sent to support all the audio data captured. The user device determines if the full audio communication has been received (block 740). If the full audio communication has been received, then the message capture capability is unlocked. For example, the talk button may be enabled.

In one embodiment, the completion of the audio communication is indicated in the final message received as part of the audio communication. For example, the last message received may include an “end of message” indication, which indicates to the user node device that the full audio communication has been transmitted. If the full audio communication has not been completed, the user node device may determine if a time period has expired (block 750). In one embodiment, the user node device may lock out the message capability until an “end of message” indication is received. In this embodiment, if the “end of message” indicator is not received due to a corruption of a message, the user node device will continue to lock out the user's capability of capturing a new message. Therefore, a timeout can be used to trigger the unlocking of the message capture capability if a new message is not received by the user node device within a predetermined time from the last message received. If the time period has expired, the user node device may unlock the message capture capability (block 755), and return to wait for a message (block 710).

In an alternative embodiment, the user node device only locks itself out of message send capability (block 730) for audio messages. Similarly, alternative embodiments to FIG. 5 and FIG. 6 are within the scope of the present invention to allow multiple messages to be sent and received between micronet members substantially simultaneously. For example, user node devices may transmit location information simultaneously to receiving a voice message from another member of the micronet group. It is also possible to receive multiple messages at the same time. For example, non-voice messages may be interspersed with segments of a voice message.

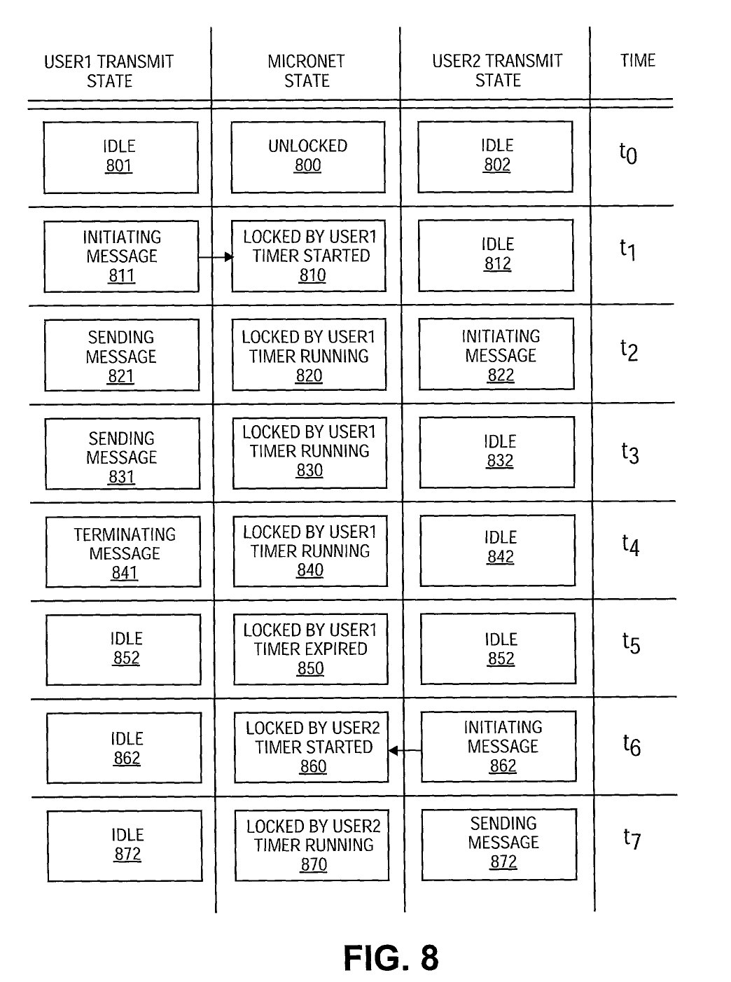

FIG. 8 shows an example series of user transmit states and corresponding micronet lock states in a time-line to illustrate how micronet locking and unlocking may be performed. These states are related to blocks 535-545 of FIG. 5 and blocks 640-660 of FIG. 6. The user1 transmit state, micronet state, and user2 transmit state are shown at various times. At time to, the transmit states 801, 802 are idle, and the micronet state 800 is unlocked. When a transmit state is idle, the user is neither initiating nor sending a message. At time t₁, user1 initiates a message (state 811) which causes the micronet state to change from unlocked to locked and a timer is started (state 810). During this time-frame, user2 is idle (state 812). At time t₂, user1 is sending a message (state 821) and the micronet continues to be in a locked state with the timer running (state 820). User2 initiates a message (state 822). Because the micronet is locked, user2's attempt at initiating a message fails and user2's transmit state returns to idle (state 832) at time t₃. User1 continues to send a message (state 831) and terminates the message (state 841) at time t₄.

The micronet state remains locked while the timer is running (state 840) and continues to be locked after the timer expires (state 850) in t₅. In this example, the micronet is in a locked state until two conditions are met: the timer has expired and a new message is initiated. Therefore, at time t₅, the micronet state remains locked even though both user transmit states are idle (state 851) and (state 852). At time t₆, user2 initiates a message (state 862) which causes the lock by user1 to be released, the micronet state to be locked by user2 and a timer is started (state 860). At time t₇ user2 sends a message (state 872), and user1 is idle (state 871). The micronet state will remain locked by user2 until the timer expires and another message is initiated by a user. Until that time, user1 will not be able to initiate a message.

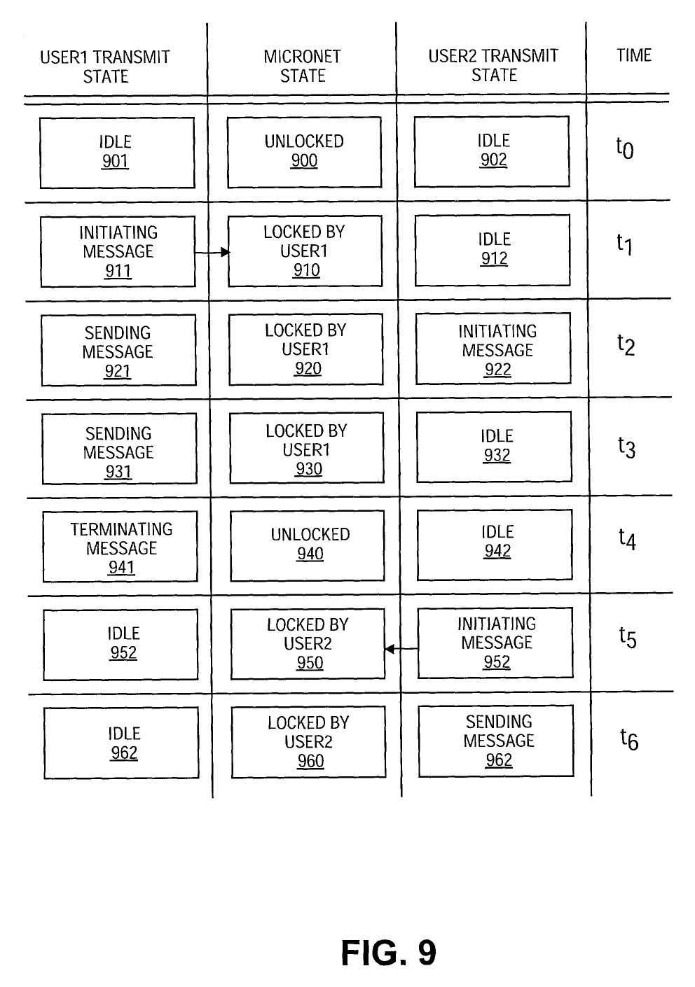

FIG. 9 shows another example series of user transmit states and corresponding micronet lock states in a time-line. In this example, a timer is not used. At time t₀, the transmit states 901 and 902 are idle, and the micronet state 900 is unlocked. At time t₁, user1 initiates a message (state 911) which causes the micronet state to change from unlocked to locked. During this time-frame, user2 is idle (state 912). At time t₂, user1 is sending a message (state 921) and the micronet continues to be in the locked state 920. User2 initiates a message (state 922). Because the micronet is locked, user2's attempt at initiating a message fails and user2's transmit state returns to idle (state 932) at time t₃. User1 continues to send a message (state 931) and terminates the message (state 941) at time t₄, and causes the micronet state to be unlocked (state 940). In this example the micronet state is locked as a result of a initiation of a message and unlocked as a result of the termination of a message.

The micronet state remains unlocked until a new message is initiated, in this case by user2 (state 952) at time t₅, and the micronet state changes to locked by user2 (state 950). At time t₆, user2 sends a message (state 962). The micronet state will remain locked by user2 until user2 terminates the message. Until that time, user1 will not be able to initiate a message.

Note that the discussion of micronet locking in relation to FIGS. 5-6 and FIGS. 8-9 and the discussion of user device operation in FIG. 7 generally applies to half-duplex operation. Micronet and user device locking may be used for simplex, half-duplex, and full-duplex operation, although alternative methods may be used to restrict message transmission and/or reception by a communication device (e.g., user node device, router, access point, etc).

FIG. 10 illustrates an example application of one embodiment of the invention to an operating area 1000. The operating area 1000 includes an attraction 1010, a restaurant 1100, a pond 1200, and a carousel 1300. These locations are equipped with a nearby access point (1051, 1052, 1053, 1054 respectively). Upon entering the operating area 1000, patrons may visit the communication center 1060 which houses a router 1070 and an assigner device 1090. The patrons may rent user node devices and have the user node devices assigned to a micronet with a corresponding exclusive communication channel. In the illustration shown in FIG. 10, three groups of patrons have rented user node devices and formed three separate micronets: A, B, and C.

Micronet A consists of members 1030 in line for the attraction 1010, member 1110 at the restaurant 1100, and members 1210 by the pond 1200. The members 1030 may send a message to member 1110. The message initiated by the members 1030, captured and transmitted by the user node device they are using, will be received by the access point 1051 coupled to the attraction 1010. The message will then be relayed from the access point 1051 to the router 1070 over a wire communications channel 1080.

The router 1070 will then relay the message to access point 1052 coupled to the restaurant 1100. The restaurant access point 1052 sends the message to user node devices in range, and since a group ID in the message may be recognized by the user node device used by member 1110, member 1110 receives the message. Members 1210 also receive the message since they are members of micronet A. The pond access point 1053 is not coupled directly with the router 1070. Instead, the restaurant access point 1052 serves as a repeater to extend the range of the communication system and relays the message from the router 1070 to the pond access point 1053 via a wireless transmission channel 1085. Patron 1220 does not receive the message from the pond access point 1053, even though he is in range, because his user node device is assigned to a different exclusive communication channel for micronet B, and rejects the micronet A message.

Member 1120 of micronet B calls the members of micronet B to locate micronet B member 1220. The members 1310 receive the message from member 1120. The message travels from member 1120 to the restaurant access point 1052 and then to the router 1070. From the router 1070, the message travels back to access point 1052 and onto both access points 1053 and 1054 where there are micronet B members in range. The message was not sent to access point 1051 from the router 1070 because no micronet B members are in range of access point 1051. Member 1310 responds that he does not know the location of member 1220. Member 1220 does not respond. However, member 1220 has a small user node device attached to his clothing that includes a location device. Member 1120 approaches kiosk 1130 and activates a location feature on his user node device.

The location feature sends a location request to the communication center 1060 to request location information for each member of micronet B. The router 1070 sends a location request to each access point. The access points then send location requests to user node devices assigned to micronet B, and the user node devices respond with location information which is sent back through the access points to the router 1070. The router 1070 then sends the location information to the kiosk 1130 which displays the location of each member of the micronet B. The expanded view 1140 of the kiosk display indicates the location of each member assigned to micronet B in reference to the layout of the operating area 1000. Members 1040 and 1320 of micronet C did not receive any of these messages because they are on a separate exclusive micronet channel.

In alternative embodiments, the present invention may be implemented in hardware, firmware, or software. In the foregoing description, the invention is described with reference to specific exemplary embodiments thereof. It will, however, be evident that various modifications and changes may be made thereto without departing from the broader spirit and scope of the present invention as set forth in the appended claims. The specification and drawings are to be regarded in an illustrative rather than a restrictive sense.

I claim:

1. A method for communication comprising:
identifying a group of selected members;
assigning the members of the group to a communication channel, wherein the communication channel is exclusive to the members of the group;
initiating communication without entering an identification number corresponding to the recipient of the communication; and
communicating between members of the group over the exclusive communication channel.

2. The method of claim 1 wherein identifying a group of selected members includes identifying a group of user node devices.

3. The method of claim 1 wherein assigning the members of the group to an exclusive communication channel includes assigning the members of the group to an exclusive communication channel dynamically.

4. The method of claim 1 wherein communicating between the members of the group includes communicating voice messages.

5. The method of claim 1 wherein communicating between the members of the group includes communicating data messages.

6. The method of claim 1 wherein communicating between the members of the group includes communicating location information.

7. The method of claim 1 further comprising updating the selected members of the group, wherein updating includes changing members of the group.

8. The method of claim 1 further comprising:
identifying a subset of the group of the selected members, wherein the number of members in the subset is less than the number of members in the group of selected members; and
assigning the members of the subset of the group to a communication channel, wherein the communication channel is exclusive to the members of the subset of the group.

9. The method of claim 4 wherein communicating between the selected members of the group further includes communicating location information on a separate channel from the exclusive channel used to communicate voice messages between the members of the group.

10. The method of claim 6 wherein communicating location information includes sending location information to an external display device

11. A communication system comprising:
at least two user node devices; and
at least one device to dynamically assign an exclusive communication channel for the at least two user node devices.

12. The communication system of claim 11 further comprising at least one access point to communicate with at least one user node device.

13. The communication system of claim 11 further comprising at least one router to communicate with at least one user node device.

14. The communication system of claim 11 wherein the at least one device to dynamically assign an exclusive communication channel includes a bar code scanner.

15. The communication system of claim 11 wherein the at least one device to dynamically assign an exclusive communication channel includes a programmer to program identification information.

16. The communication system of claim 11 further comprising at least one display device to indicate the location of at least one user node device.

17. The communication system of claim 12 wherein at least one of the at least one access point includes a router.

18. The communication system of claim 12 further comprising at least one router to communicate with the at least one access point.

19. The communication system of claim 12 wherein the at least one access point communicates with at least one access point.

20. The communication system of claim 13 further comprising at least one access point to communicate with the at least one router.

21. The communication system of claim 14 wherein the at least one router communicates with at least one router.

22. The communication system of claim 16 wherein the at least one display device is coupled to at least one of the at least two user node devices.

23. The communication system of claim 16 wherein the at least one display device is external to at least one of the at least two user node devices.

24. The communication system of claim 18 wherein the at least one router communicates with at least one user node device.

25. The communication system of claim 20 wherein the at least one access point communicates with at least one user node device.

26. A user node device comprising:
an access device to communicate over a communication channel; and
a group identification device coupled with the access device to be used by an assigner device and a communication device, wherein the assigner device assigns the user node device to a user defined group of member user node devices which has a corresponding exclusive communication channel solely for the members of the user defined group, and wherein the communication device excludes any user node devices which are not members of the user defined group from communicating over the exclusive communication channel and enables the members of the user defined group to communicate over the exclusive communication channel.

27. The user node device of claim 26 further comprising a user input device.

28. The user node device of claim 26 further comprising a device to initiate and terminate capturing of information to be transmitted.

29. The user node device of claim 26 further comprising a user output device.

30. The user node device of claim 26 further comprising a location device.

31. The user node device of claim 26 wherein the access device is a transmitter.

32. The user node device of claim 26 wherein the access device is a receiver.

33. The user node device of claim 26 wherein the access device is a transceiver that includes a receiver and a transmitter.

34. The user node device of claim 26 wherein the group identification device includes a programmable identification.

35. The user node device of claim 26 wherein the group identification device includes a bar code.

36. The user node device of claim 27 wherein the user input device is a microphone.

37. The user node device of claim 27 wherein the user input device is a keypad.

38. The user node device of claim 29 wherein the user output device is a speaker.

39. The user node device of claim 29 wherein the user output device is a display device.

40. The user node device of claim 33 wherein the transceiver is an IEEE 802.11 b standard compliant transceiver.

41. The user node device of claim 39 wherein the display device displays location information.

42. The user node device of claim 39 wherein the display device displays text messages.

43. A user node device comprising:
an access device to communicate over a communication channel;
a group identification device coupled with the access device to be used by an assigner device and a communication device, wherein the assigner device assigns the user node device to a user defined group of member user node devices which has a corresponding exclusive communication channel solely for the members of the user defined group, and wherein the communication device excludes any user node devices which are not members of the user defined group from communicating over the exclusive communication channel and enables the members of the user defined group to communicate over the exclusive communication channel;
a user input device to create messages to be transmitted by the transceiver; and
a user output device to present information received by the transceiver to a user.

44. The user node device of claim 43 further comprising a location device.

45. The user node device of claim 43 further comprising a button to initiate and terminate capturing of information to be transmitted.

46. The user node device of claim 43 wherein the user input device is a microphone.

47. The user node device of claim 43 wherein the user output device is a speaker.

48. The user node device of claim 43 wherein the group identification device includes a bar code.

49. The user node device of claim 43 wherein the group identification device includes a programmable identification.

50. The user node device of claim 43 wherein the access device is a transceiver

51. The user node device of claim 43 wherein the access device is a receiver.

52. The user node device of claim 43 wherein the access device is a transmitter.

53. The user node device of claim 50 further comprising a device to disable the user input device.

54. The user node device of claim 50 further comprising a device to disable the user output device.

55. An apparatus for channel assignment comprising:
a grouping device to select a plurality of user node devices as members of an exclusive group; and
a channel assignment device to assign the members of the selected exclusive group to an exclusive communication channel.

56. The apparatus for channel assignment according to claim 55 wherein the grouping device includes a bar code scanner.

57. The apparatus for channel assignment according to claim 55 wherein the grouping device includes a programmer to program a group identification information into at least one of the plurality of member user node devices of the exclusive group.

58. The apparatus for channel assignment according to claim 55 wherein the channel assignment device comprises a computer coupled with the grouping device processor.

59. The apparatus for channel assignment according to claim 55 wherein the channel assignment device generates a member list including identification information of the member user node devices of the group.

60. The apparatus for channel assignment according to claim 59 wherein the member list is used by a communication device to allow communication between member user node devices and to prohibit communication between member user node devices and nonmember user node devices.

61. A computer-readable medium having stored thereon a sequence of instructions, the sequence of instructions including instructions which, when executed by a processor, causes the processor to perform:
identifying a group of selected members; and
assigning the members of the group to a communication channel, wherein the communication channel is exclusive to the members of the group.

62. The computer-readable medium of claim 61 further comprising instructions which, when executed by the processor, causes the processor to perform:
forming a user defined group list, wherein the list includes information relating to each member of the user defined group.

63. The computer-readable medium of claim 62 further comprising instructions which, when executed by the processor, causes the processor to perform:
storing the user defined group list.
